(19) United States
(12) Patent Application Publication
(10) Pub. No.: US 2004/0199867 A1
(43) Pub. Date: Oct. 7, 2004

(54) Content management system for managing publishing content objects

(75) Inventor: Thomas Brandenborg, Arhus C (DK)

Correspondence Address: HARNESS, DICKEY & PIERCE, P.L.C., P.O. BOX 8910, RESTON, VA, 20195, US

(73) Assignee: CCI Europe A.S.

(21) Appl. No.: 10/735,713

(22) Filed: Dec. 16, 2003

Related U.S. Application Data
(62) Division of application No. 09/590,096, filed on Jun. 9, 2000, now abandoned.

(30) Foreign Application Priority Data
Jun. 11, 1999 (DK) PA 1999 00827

(51) Int. Cl. G06F 7/00

(52) U.S. Cl. 715/500.1; 707/104.1

(57) ABSTRACT

A content management system for use in news media production, including data storage data retrieval data processing where a database system is adapted to store publishing content objects (PCOs) and metadata. The metadata may be associated with PCOs in the content management system. The system may also include a number of workstations where the PCOs are stored in a media neutral format to enable re-use of the PCOs in publications of multiple media. The content management system may further be adapted to perform a task of planning and co-ordinating usage of PCOs in one or more publications.

### FIELD OF THE INVENTION

The present invention relates to a content management system for news publishers. The system provides a comprehensive “content focused” news publishing solution. The system is capable of integrating publishing contents management tasks such as planning, creating, budgeting, organizing, retrieving, storing, searching, tracking and distributing contents through diverse news media such as newspapers, magazines and electronic news media. The budgeting of content for publishing is a dynamic budgeting which enables a subset of the content objects on a given layout budget to be selected for publishing automatically according to a set of conditions.

The present content management system is capable of providing significant cost and time efficiencies in managing large numbers of complex tasks that characterize editorial environments in the news publishing industry.

### BACKGROUND OF THE INVENTION

Content management systems have traditionally been based on computer systems and programs adapted to solely manage contents that already exist, such systems commonly being referred to as asset management systems. These asset management systems are capable of managing and providing long-term archival of large number of documents and various content objects and the systems are typically used by e.g. advertisement agencies or large enterprises. Also, systems for management of contents including the tasks of planning, creating and organizing contents for electronic publication e.g. on the Internet have been on the market.

Publication management systems are known from the prior art, such as WO 94/03310, which relates to a publication system for coordinating access to publication data and related information on a network of computers. The systems is suitable for planning and performing the creation of content for publication based on the layout of the planned publication, i.e. a new item of content is typically assigned a position and a size in the publication upon creation. Content items may be created without such budgeting, but the budgeting of use of the content item may only be performed by means of such an assignment of position and size in the publication upon creation. Thus, the budgeting of use of the content items is static in the sense that content items are either on a budget with a well-defined position and size or the content item is off the budget.

However, such prior content management systems have not been able to support the large number of diverse tasks required to manage news contents targeted for publication in printed news products such as newspapers, weeklies, magazines, etc. and also support the rapidly evolving electronic news media. The type of management tasks supported by these asset management systems will be insufficient to requirements of the news publishing, primarily due to the dynamic process involved in planning, creating and organizing news contents for one or several news publishing products, such as newspapers, magazines, radio programs, online products etc. Furthermore, most news organizations publish not only a single printed newspaper and its various zones, but also a number of niche and other printed publications.

Many of the larger publishers are also involved in broadcasting of radio and TV news and participation in partnerships with a number of other newspapers, either in the same group or through syndication, wire services and other partnerships. This trend towards diversification is largely driven by an increasingly fierce competition (particularly for advertising revenue) from non-traditional sources, which forces newspapers to think in new products and new media.

Consequently, news publishers are increasingly focused on creating, managing, promoting and distributing publishing contents through diverse channels, and less focused on “just” producing a newspaper or a magazine. In order for their content gathering and creation to become as efficient and competitive as possible, these news publishers want to implement a content focused newsroom. A such “content focused” newsroom should be capable of providing high levels of contents sharing between different news products, e.g. a newspaper product and a World Wide Web product, and between disparate newsrooms. These news publishers also want the capability of promoting their contents as broadly as possible through syndication and other channels in order to maximize the value of those contents. The present content management computer system is capable of supporting and assisting such a “content focused” environment by applying an aggressive database approach to deliver a collaborative content repository with publishing-specific functionality. Furthermore, the present system is capable of being fully integrated with proven editorial, pagination and production systems or modules available from the present applicant. Such a fully integrated system can act as a single platform for all content related activities within the editorial environment.

### SUMMARY OF THE INVENTION

It is an object of the invention to provide a content management computer system that may function as a full-fledged repository for managing all sorts of publishing contents in a single database, or across distributed databases, with dedicated features for planning, creating, budgeting, organizing, retrieving, archiving, searching and tracking content in a shared editorial environment of a news publisher and various associated alliance partners, in which the budgeting of content for publishing is a dynamic budgeting that enables a subset of the content objects on a given layout budget to be selected for publishing automatically according to a set of conditions.

It is another object of the invention to provide a content management computer system which is based on one or several databases that store(s) the publishing contents as Publishing Content Objects (PCOs) with associated metadata fields describing the objects, such as their purpose, their origination, their state, their type, their deadline etc.

It is also an object of the invention to provide a content management computer system wherein a group of one or several of the PCOs with associated metadata fields may be grouped into a logical entity called an assignment. A system user may conveniently manage the PCOs within the database system by managing the assignments instead of having to manage the one or several PCOs of the assignment.

It is also an object of the invention to provide a content management computer system which is particularly well adapted to the requirements of newspaper and magazine publishers, but at the same time integrates the management of publishing contents targeted for other media, printed as well as electronic media.

Finally, it also an object of the invention to provide a content management computer system capable of organizing several assignments into at budget targeting a particular publishing product by recording valid information into one or several metadata fields, thereby associating the assignments with the relevant budget.

One of the most important objects of the invention, however, is to control the whole process of managing publishing contents objects. In this regard, it is extremely valuable that the concept of an assignment can be established at the earliest stage, even when the PCO proper has not been created or stored, the assignment, then, being created at the creation of the first metadata that will be related to the PCO.

Other objects of the present invention will be apparent from the following description.

### DESCRIPTION OF THE INVENTION

Thus, the present invention relates to a content management system for use in news media production, comprising:

data storage means, data retrieval means and data processing means,

a database system adapted to store publishing content objects (PCO) and metadata,

a number of workstations,

means to support users to perform at least all of the following management tasks from one of the workstations or several of the workstations in co-operation:

creating metadata and archiving the metadata in the database system,

planning of the creation of a PCO to be associated with metadata defined in the content management system.

creating PCOs,

archiving PCOs in the database system,

searching and retrieving PCOs from the database system,

associating metadata defined in the content management system with a PCO defined in the content management system,

budgeting metadata defined in the content management system by associating the metadata with one of a plurality of layout budgets being defined within the content management system, each layout budget having a target publishing product associated therewith,

grading metadata defined in the content management system by associating one out of at least two grades with the metadata, the grades being predefined in the content management system,

wherein the content management system further comprises means for executing a layout budget by performing a selection of a subset of the metadata on the layout budget and the PCOs associated therewith for publication of the PCOs in the target publishing product associated with the budget, the selection being dependent on the grading of the metadata.

In the present specification and claims, the term “database system” is to be understood as one or several co-operating databases. Since a database is basically a collection of data or information which has been organized for ease of search and retrieval, the database system may comprise a single database of a particular structure which may be controlled by a particular database program, such as an Oracle SQL database and program. The database system may also comprise several databases of similar or different structure and these databases may reside at the same or at different geographical locations. Accordingly, PCOs may be addressed, stored and retrieved from a remote database or databases forming part of the database system independent of whether the remote database(s) has the same structure as a “local” or native database typically located at news publisher's residence stored. This capability of transparently storing and retrieving PCOs independent of database structures and locations is a major advantage of the present invention, since users of the present content management system may manage any PCO in a straight-forward manner. Furthermore, system users may also include the PCOs in assignments, projects, associations and budgets as well as performing various other tasks required to organize and monitor the workflow related to creating and publishing a number of diverse news publishing products.

It is presently preferred to implement the computer system as a client/server relational database with data object facilities. The database program as well as entered/created publishing content data may be stored in one or more hard-disc drives comprised within the server or server means and loaded into RAM memory of the server means during program execution.

As an example, the database system may comprise one or several Oracle SQL databases running on a server or servers of the computer system, preferably an AIX or UNIX server(s) provided with mirrored disks.

Database fields are related to the publication of the PCO in a particular publishing product, and a set of fields which is meaningful in the context of a specific target product is, preferably, defined. As an example, metadata fields related to the section, zone, page number and classification may only be relevant fields for newspaper and magazine products containing the PCO. For Internet publishing products containing the PCO, a relevant field may be a count value specifying a number of hits for which the PCO is to be maintained or, alternatively, the publication start time and end time of the PCO, One, or several of the workstations in co-operation, is/are adapted and enabled to perform at least the above-mentioned management tasks which are defined below

In the present specification and claims, the term “PCO” designates each generic lump of “publishable” data such as a text, a photo or a graphic image. Substantially each PCO is associated with several metadata fields describing the object. These metadata may be arranged in several ways in the database and the data of one or several fields may be encapsulated together with their associated object. An assignment

These PCOs are the objects that need to be created and managed in the content management system according to the present invention, regardless of their physical object structure and regardless of any other type of objects that an integrated or stand-alone production system may deal with. The term was chosen to distinguish such PCOs from any other database objects that may be stored in the database system without being subject to content management functionality.

In the present specification and claims, the term “metadata” designates all types of data associated with data representing a PCO. Metadata can be interpreted as a “wrapping” around the PCO allowing system users such as editors, reporters and photographers to evaluate what is “inside the package” (i.e. the content object), without having to actually open, study and “digest” the object. In the present database system, these metadata are preferably organized as a number of database fields associated with each PCO each field may comprise information about a particular aspect or property of the associated object such as author of the object, type of the object, status of object, deadlines for creating and publishing the object etc.

Besides allowing content objects to be described for purposes of planning, organizing, tracking and retrieval within the editorial environment, metadata are also crucial in promoting the contents broadly through syndication and wire and even to end users—and hence one of the most important means for increasing the value of content assets.

In the present specification and claims, the term “planning” PCOs designates the process of entering into the database system one or several fields of metadata associated with a PCO. These metadata fields may be entered or recorded before or during the creation of the associated PCO. This feature is particularly valuable since it allows the editorial staff of a news publisher to plan and record important PCOs in connection with e.g. major news events such as sport games, holidays, celebrity birthdays, political or medical conferences etc. well in advance of the actual event.

In the present specification and claims, the term “creating” PCOs designates the process of generating and storing PCOs in the database system. For printed products such as newspaper products, the PCOs are often text files, e.g. Word files or similar word processing files, and/or picture files and/or graphic files created by the reporters, photographers, desktop publishing operators commonly employed in a newspaper editorial environment. For online products targeted for e.g. Internet publication, these objects could be HTML files, sound or video clips etc.

In the present specification and claims, the term “searching” the PCOs designates the task performed by the data processing means of the system of reading and filtering or sorting the metadata fields associated with the PCOs for a particular target value or values. The relevant target value(s) or search criteria may be recorded into a search window by a user and a database request submitted for searching the database for the one or several PCOs that have associated metadata fields matching the requested target value. Since PCOs may be stored in one great big database pool, accessible by all users of the database system in all co-operating newsrooms (given proper access permissions, of course), the filtering process allows users to search for and see only the PCOs they need and/or want to see at a given time.

In the present specification and claims, the term “retrieving” the PCOs designates the task performed by a database program in retrieving a PCOs targeted by a user and optionally opening the PCO by an application program determined from the field value of the metadata field specifying the type of the object.

The computer system used for storing and running the database system according to the invention may be any suitable conventional or proprietary computer system. Preferably, a client/server architecture is utilized for the above-mentioned individual elements of the computer system. This architecture reduces the load on the publishing content database system and guarantees a quick response time for the end users or operators. The client workstations are, preferably, personal computers (PCs) running a Windows NT operating system.

In the present specification and claims, the term “budgeting” PCOs designates assisting the editorial filtering and selection process (the editors task of deciding which content to publish in a given news publishing product and how the content are played or presented in that product). Accordingly, a budget can be viewed as a logical entity within the database system, the entity comprises a list of assignments, often related to news stories (or other contents). This entity is utilized by the editorial staff to keep track of available PCOs. Thereby, the budgeting provides an interface between content management and production/space planning tasks that deal with configuration and layout of a news publishing product.

Editorial computer systems currently available on the market for newspaper publishers use simple text files to enter, edit and store budgets, with established conventions for the layout of each entry.

Most newspapers maintain a number of budgets for different purposes, specifically:

Desk Budgets: These have traditionally served as a tool for each assignment editor in maintaining budgets of stories from his or her desk. We call these Desk or Origination Budgets. Often, separate budgets are maintained for “current” and “upcoming” assignments or stories.

Layout Budgets: The news desk usually maintains budgets of assignments for each day's paper a week or two ahead. We call these Layout Budgets. These may be divided into budgets for sections, section fronts, zones and online products. A particularly important budget is A1, listing those stories that are front page candidates. Assignments often start in desk budgets, and are later copied to layout budgets when an assignment editor chooses to submit them for tomorrow's (or some other day) paper. Thus, the same assignments usually appear in their originating desk budget as well as a layout budget. For the present use of the term budgeting is understood associating the metadata with a layout budget.

The content management system according to present invention has the ability to add rich metadata to the PCOs and, subsequently, browse these metadata in user defined list windows. These features provide very significant advantages for the editorial staff in its editorial budgeting process. Once the metadata associated with budgeting are recorded and or entered as fields on the actual PCOs, the need to maintain budgets as text files is completely eliminated. Instead, budgets are simply generated by filtering the stored PCOs in the database for objects with specific field values. In particular, the concept of desk budgets is completely replaced by filtering in list windows for contents from a specific desk and, optionally, a given date interval. Hence, there is no requirement for a desk budget in an editorial environment operating in accordance with the workflow provided by the present content management system.

Layout budgets are utilized as a tool for selecting and filtering contents to be included in a specific issue and edition of a news product, and for determining how and where to play those contents. Layout budgets form a topical partitioning of the product by dividing it into logical units—which may or may not reflect physical sections—and designating a budget name to each such unit. By associating a story with a specific budget, it is submitted for approximate positioning within the news product, even though its exact position and layout—or indeed, whether it will be played at all—has not yet been determined. The subject of budgeting will be further discussed in more detail in the text describing a preferred embodiment of the invention.

The grading of the metadata is preferably implemented by adding a grading to a specified data field of the metadata but may also be implemented as one or more separate lists of identified metadata. The grading is importing in assisting the content management system in selecting the relevant subset for publishing from a layout budget. The grading itself may be of a number of different forms but the selection process, which preferably is effectuated automatically, allows for a dynamic use of the layout budget, which allows editors and other personnel to budget the use of a PCO, which may actually only be a planned PCO, on a budget where it MAYBE will be used for publishing and add a grading (or more gradings) to the PCO by means of its metadata so as to qualify this MAYBE. The grading may be, and will usually be, changed during the creation process of the PCO.

One type of grading, and more types may be used in the system according to the invention, is enabled in a management system, wherein the means for grading metadata comprises means for ranking metadata defined in the content management system by associating one out of a plurality of ranks with the metadata, the ranks being predefined in the content management system, the selection performed by the execution of a layout budget being dependent on the rank of the metadata on the given layout budget.

The ranks may be of different types and it is preferred that the ranks have a mutual well-defined relationship, so that the mutual hierarchical relation of the ranks is predefined in the content management system and the selection performed by the execution of a layout budget being dependent on the rank of the metadata on the given layout budget as well as on the hierarchical relation of the ranks.

Another type is an on-off type of grading, so that the means for grading metadata comprises means for approving metadata defined in the content management system by switching an approvement state of the metadata between ‘approved’ and ‘not approved’, the selection performed by execution of a layout budget being dependent on the approvement state of the metadata on the given layout budget.

As an assistance for the selection process the content management system may further comprise means for associating a size with each PCO, the size being indicative of the spatial or temporal extent of the PCO when appearing in a target publishing product, the selection performed by the execution of a layout budget being dependent on the size of the PCOs associated with the metadata on the layout budget as well as a predefined maximum total size of the layout budget in question. This function may be used in co-operation with one or more of the gradings discussed above.

A “roll-over” to the layout budget of the next issue of the similar publication of the PCOs that have not been selected for publication may also be advantageous to include in the system according to the invention. Such a content management system has means for executing a layout budget that comprises means for associating at least some of the metadata on the budget which are not selected with another layout budget for a target publishing product.

In particular, each layout budget may have a publication time associated therewith indicating the publication time and/or date of the target publishing product of the layout budget and the means for executing a layout budget may comprise means for associating at least some of the metadata on the budget which are not selected with another layout budget for a target publishing product having a later publication time than the layout budget being executed.

Further, the means for executing a layout budget may comprise means for applying an indication to the metadata that have been associated with another layout budget by the means for executing the layout budget.

The content management system is in most cases intended for use with a vast number of workstations and it is preferred that at least one workstation user and preferably the users of all workstations are provided with consolidated access to the database system with transparent access to and management of all PCOs in the database system in connection with any of the above management tasks irrespective of the storage location within the database system of any particular PCO.

The database system may in particular comprise several different databases, which may be physically or geographically disparate, and the consolidated access to the database system is provided through a single Graphical User Interface irrespective of the storage location of any particular PCO.

In order to manage the databases of the database system efficiently, it is furthermore preferred that each database of the several different databases comprises a searchable index file of the metadata associated with the PCOs stored in that database. Each database of the several different databases may also be adapted to store PCOs and metadata associated therewith for a particular enterprise or a branch of the enterprise and wherein the searchable index files are replicated into respective synchronized enterprise index files, the synchronized enterprise index files supporting the consolidated access to the stored PCOs in the database system.

The content management system may further comprise means to support users from at least one workstation to perform the management task of tracking the status of PCOs.

In the present specification and claims, the term “tracking” PCOs generally designates monitoring or keeping track. of progress in creating already planned PCOs. Assignment editors or reporters can use the tracking functionality provided in the present content management system to monitor the status of the underlying content—i.e. whether the relevant PCO is only planned, is actually assigned to someone, is currently being edited, or released for publication. The present content management system may additionally be adapted to generate various actions responsive to a PCO reaching a certain predetermined state, e.g. a photographer who belongs to a certain assignment may be notified when an article belonging to the same assignment has been released for publication by an assigned reporter.

According to a preferred embodiment of the present invention, a Modification Log metadata field is provided in the database system. The Modification Log operates as a dynamic notes field where each entry is stamped with date/time and user name. When editors and reporters edit an assignment or a PCO they can add comments here as to what they were doing and why.

The content management system may further comprise means to support users to perform from at least one workstation the management task of associating metadata defined in the content management system with one of a plurality of desk budgets being defined within the content management system.

It is preferred that the content management system further comprises means to support users from at least one workstation to perform the management task of organizing PCOs into groupings.

In the present specification and claims, the term “organizing” PCOs generally designates a process of relating PCOs stored in the database system in meaningful ways, thereby assisting the editorial the production workflow. Relating the PCOs in meaningful ways may be implemented in various ways, the PCOs may be grouped into projects. This grouping could be provided by creating in the database system dedicated metadata fields for each PCO and recording in these fields a project identifier, thereby establishing a project or projects that any given PCO belongs to. Other methods for grouping PCOs are preferably also provided since the project method described may not meet all the requirements in a content management environment for news publishers. Specifically, the grouping of PCOs into projects requires that projects have to be created as separate entities.

We may associate PCOs with each other for the sole purpose of creating topical relationships, even between objects that are not necessarily packaged into the same physical article. For the remainder of this specification, we shall refer to such relationships as Associations, because they may associate PCOs with each other for a number of different purposes, such as:

Associating Stories with Photos or Graphics

Assignment editors and reporters need to link existing photos or graphics to a story or create requests for photos or graphics to be created. In either case, the resulting photo(s) or graphic(s) should be associated with the story. Such associations can be used to later form articles in print or online products.

Associating Related Stories

Otherwise unrelated stories (e.g. the stories do not already belong to the same project) can be associated if they touch on the same subject, cover different aspects of a story, quote the same people—or for whatever other reason editors and reporters see fit Such associations may—or may not—cause the stories to be packaged when they are published, or they may be used to generate hyperlinks in online products.

Associating Wires with Stories

When a wire is used in a story, an association could be created, allowing users looking at the story to see which wire was used and, even more importantly, allowing users looking at wires to see in which story a wired has been used. If multiple wires are used in a single story (such as for digests) they all belong to the same association.

According to a preferred embodiment of the invention, these requirements are addressed by allowing content objects to be members of one or several “families” or Associations of related objects. Associations could be considered ad hoc projects, because they are not required to have visible names and may be created on the fly whenever an editor or reporter recognizes that objects are associated with each other.

Associations may provide the present content management system with a number of important and powerful properties for management of news publishing contents such as:

The ability to easily create and update relationships between two or more PCOs.

The ability from any PCO to easily display all related objects

The ability for each PCO to participate in any number of associations.

In particular, the means for organizing PCOs into groupings may comprise

means for defining projects in the content management system, each project having a unique identifier defined,

means for including a PCO in a project by adding the unique identifier o. the project to a specified field in metadata associated with the PCO, and

means for filtering metadata stored in the database system and presenting an output of metadata and/or PCOs associated therewith, which metadata in said specified field comprise a given unique identifier of a given project defined within the content management system.

In order to include metadata that do not have a PCO associated with it into a defined project, it is further preferred that the content management system comprises

means to support users from at least one workstation to perform the management task of including metadata in a project by adding the unique identifier of the project to a specified field in said metadata, and

means for filtering metadata stored in the database system and presenting an output of metadata, which metadata in said specified field comprise a given unique identifier of a given project defined within the content management system.

An alternative or preferably additional type is organizing of PCOs is obtained in a content management system according to the invention, wherein the means for organizing PCOs into groupings comprises

means for defining associations in the content management system, each association having a data list comprising unique identifiers of the metadata of the PCOs comprised within the association,

means for including a PCO in an association by adding a unique identifier of the metadata associated with the given PCO to the list of the given association, and

means for presenting an output of metadata and/or PCOs associated therewith, which metadata are included in a given association defined within the content management system.

The means for organizing PCOs into groupings may likewise further comprise

means for including metadata in an association by adding a unique identifier of the metadata to the list of the given association, and

means for presenting an output of metadata, which metadata are included in a given association defined within the content management system.

A much preferred-method of managing PCOs is obtained with a content management system wherein the database system comprises means for generating and storing assignment metadata and for associating the assignment metadata with one or several related PCO(s) to thereby create an assignment, the assignment being a logical entity which can be stored and managed in the database system by a workstation user. Thus, the assignment may be managed as the metadata and the PCOs associated therewith and/or as metadata as described above. In particular, the means for generating the assignment metadata may be adapted to generate at least a part of the assignment metadata through inheritance of the metadata associated with the one or several related PCO(s). The means for creating the assignment may further support the creation of the assignment irrespective of whether or not the one or several related PCO(s) has/have yet been created or stored in the database system.

In this connection, it is especially important that the means for creating the assignment enable the creation of the assignment even when only metadata is stored in the database system, irrespective of whether the PCO has yet been created or stored. As mentioned above, this makes it possible to handle the process of managing PCOs right through the whole process, even from before the PCO proper has been created or stored.

Preferably, the assignment metadata contain at least information relating to:

a description of the assignment

an origination of the assignment

a type of the assignment

a status of the assignment

at least one target publishing product of the assignment,

and optionally information relating to access control.

Furthermore, the assignment metadata may contain information relating to the description of the assignment comprise at least one of the following types of information:

a slug

keywords describing the assignment

an abstract of the assignment

notes about the assignment

a modification log of the assignment.

Yet further, the assignment metadata may contain information relating to the origination of the assignment comprising at least one of the following types of information:

an originating newsroom of the assignment

an originating desk of the assignment

an assignment editor of the assignment

an author of the assignment.

The data base system may according to a preferred embodiment of the present invention be adapted to filter those assignment metadata which comprise information relating to the origination of the assignment for a specific type of information and to display a result of the filtering on a workstation screen, thereby providing the content management system with a mechanism that supports display of any type of desk budget to any editor through appropriate selection of the specific type of information on which to filter the stored assignments on. The specific type of information may e.g. be the information relating to the originating desk of the PCO, thereby enabling any editor to select and display any specific Desk budget of the stored assignments.

The assignment metadata may further contain information relating to the at least one target publishing product comprise at least one of the following product links:

an edition of the at least one target publishing product

a logical or physical storage address in a computer system of the at least one target publishing product

a zone of the at least one target publishing product

a physical section placement in the at least one target publishing product

a physical page placement in the target publishing product

a publication date and/or time of the at least one target publishing product

a deadline for at least one target publishing product

a layout budget of the assignment

budgeted size of the assignment

a ranking of the assignment.

The database system may in particular be adapted to filter the product links for a specific type of product links and to display a result of the filtering on a workstation screen, thereby providing the content management system with a mechanism that supports display of any type of layout budget to any editor by appropriate filtering of the product links.

The database system may further be adapted to store a plurality of product links and further adapted to automatically add an assignment to a layout budget of the at least one target publishing product by recording valid information into a predetermined number of product links of the plurality of product links. In particular, the information in a name product link of the predetermined number of product links may constitute a valid name of the layout budget, and the database system being adapted to remove the assignment from the named layout budget if a different layout budget name is entered into the name product link or if the name product link is cleared.

An assignment may automatically be added to a layout budget of a printed target publishing product by recording valid information into a first predetermined number of product links and, further added to a layout budget of an electronic target publishing product by recording valid information into a second predetermined number of product links.

The assignment metadata contain in a further preferred embodiment information relating to assignment management, the assignment management information comprising at least one of the following types of information:

an address and/or name of a geographical location of a news event related to the assignment

identity of persons employed by a news publisher that are supposed to attend the news event

start time and date and/or end time and date and/or duration of the news event

contacts at the news event

appointments at the news event

links to research information or interviews related to the assignment

intellectual property rights to a PCO or PCOs associated with the assignment.

The assignment metadata may be adapted to contain at least one of the following types of information relating to access control:

rules concerning who is allowed access to any data revealing the existence of an assignment

rules concerning who is allowed access to the assignment

rules relating to when and/or under which conditions access as under the two above bullets can be obtained.

The metadata associated with the PCOs may be stored by a plurality of database fields, so that substantially each PCO stored in the database system has a number of associated metadata fields that stores the metadata of the PCO. Likewise may the metadata associated with the assignments be stored by a plurality of database fields, substantially each assignment having a number of associated assignment metadata fields that stores the metadata of the assignment.

The database system may comprise means enabling a system administrator to define one or several additional assignment metadata fields or to define one or several additional PCO metadata fields, thereby allowing customized information to be added to the assignment or PCO metadata of the database system. Preferably, substantially all assignment metadata fields are definable by a system administrator.

In order to ensure the flexibility of the system in the fast developing news communication world, it is preferred that the system comprises means enabling a system administrator to define one or several metadata fields so as to allow customized information to be added. Indeed, the system could be supplied as a structured system in which substantially all metadata fields are definable by a system administrator, thus permitting maximum adaptability to a given purpose or environment.

At least some of the types of assignments stored in the database system may be associated with particular icons, thereby allowing a user to identify the type of an assignment by a visual appearance of its icon on a workstation screen.

The assignment metadata containing information related to the status of the assignments and/or metadata containing information related to the status of the PCOs may be logged during a workflow of a news media production by means of logging means of the content management system. The database system may be adapted to store and apply workflow automation rules to the logged assignment metadata containing information related to the status of the assignments and/or the metadata containing information related to the status of the publishing content objets. In particular, the workflow automation rules may be used for:

triggering workflow events or ad hoc booked events when an assignment, or a PCO associated with the assignment, reaches a certain status, and/or

generating deadlines when an assignment, or a PCO associated with the assignment, reaches a certain status, and/or

checking the plausibility of the correctness of assignment metadata or data pertaining to an a PCO, and/or

enabling restoration of the status of an assignment or a PCO associated with the assignment.

The triggering of the workflow events or the ad hoc booked events may generate a notification message to one or several workstation users in accordance with the stored automation rules.

Alternatively, the triggering of the workflow events or the ad hoc booked events may initiate a routing of the assignment, or a publishing content object associated with the assignment between workstation users.

The workflow automation rules may in all cases comprise automation rules that are related to a particular type of assignments or a particular type of publishing content objects.

The PCOs may comprise contents of types used in news media selected from the group consisting of: daily or weekly newspapers, magazines, TV and radio stations, Internet sites and other electronic news media.

Further, the production of media output incorporating the PCOs may be enabled by a production system integrated with the database system. Preferably is at least a part of the metadata of the database system accessible by the production system. Additionally or alternatively may the database system be adapted to store at least some production data generated by the production system in the content management database system as metadata.

Finally, the content management system may further comprise means to support users from at least one workstation to perform the management task of filtering metadata stored in the database system and present an output of metadata and/or PCOs associated therewith, which metadata each in a given set of data fields, the set comprising at least one data field, comprise a given set of data.

In the present specification and claims, the term “archiving” PCOs designates permanently storing the PCOs in the database system in a manner that allows particular PCOs to be retrieved on demand for later use or re-use. The PCOs may be archived after having been published in one or several news products. However, the available physical or virtual (for electronic media) layout budget for any particular partition of a news products is usually less than the amount of available publishing contents created by reporters and editorial staff, the superfluous publishing contents may be archived for later use. The database system may be adapted to automatically perform this task based on certain predetermined rules and criteria or users of the system may select publishing contents to archive manually.

The news media may, as presently important examples, be selected from the group consisting of: newspapers, magazines, weeklies, electronic newspapers, electronic magazines, news streamers, running message displays, news-banners, TV, data carriers such as CD-ROMs, DVD discs, magnetic discs, DAT tapes, videos, radio, stationary telephones, mobile (cellular) telephones, teletext, public networks, including the Internet, inserts, onserts, and posters. Accordingly, the present system may be capable of managing a news publisher's publication content relating to any of these printed or electronic media or any combination thereof.

A number of further interesting and preferred embodiments of the invention appear from the claims and will also be understood from the below discussion of particular embodiments of the system.

### DESCRIPTION OF THE DRAWINGS

A preferred embodiment of a content management computer system for news publishers is illustrated in the drawings, wherein

FIG. 1 of the drawings illustrates a PCO (PCO) and several associated metadata fields describing the object according to the present invention,

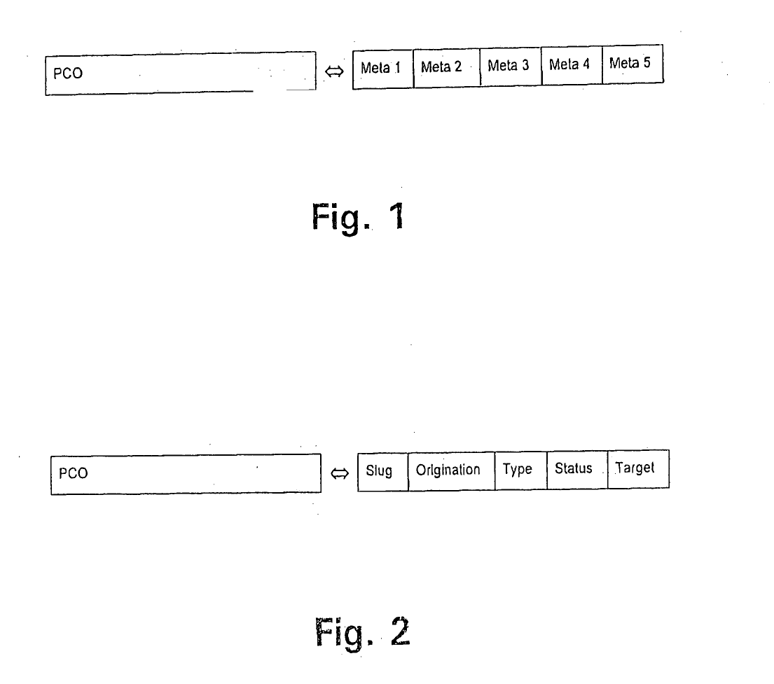

FIG. 2 of the drawing is an exemplary illustration of the PCO (PCO) and its five associated metadata fields comprising information relating to: an identity of the object in the form of a short name or slug, an origination, a type, a status and a target publishing product, respectively. It will be understood that in most embodiments, a number of additional metadata fields are further associated with each PCO stored in the database system.

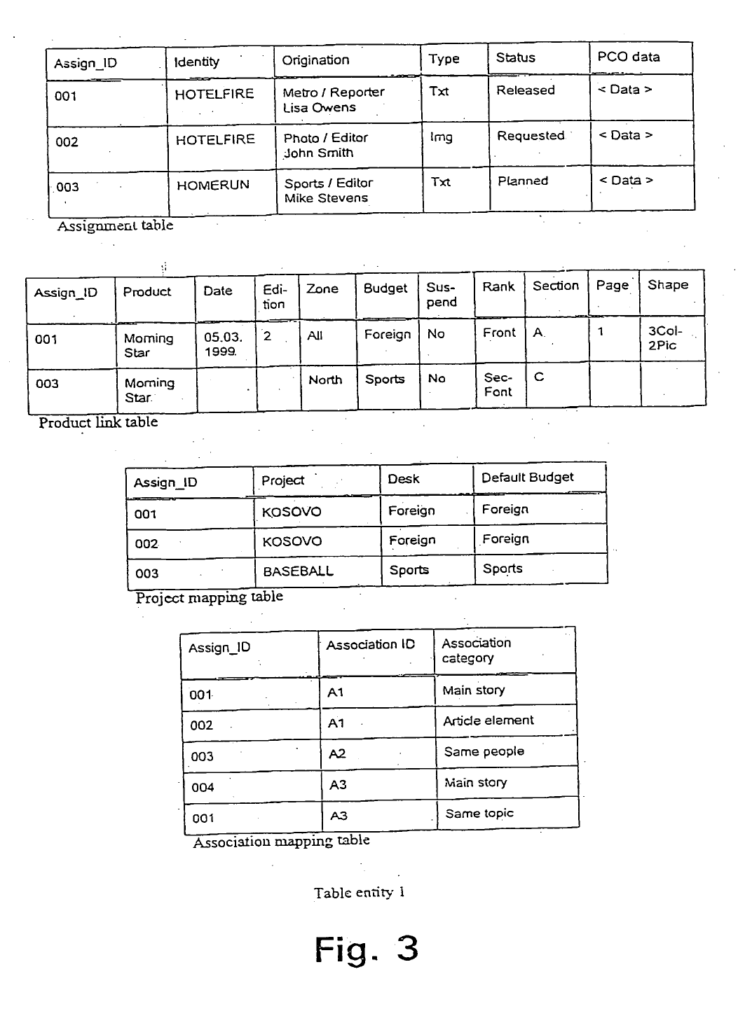

FIG. 3 of the drawings is an exemplary illustration of a table entity comprising four tables, an Assignment table, a Product link table, a Project mapping table, and an Association mapping table. This table entity is implemented within the database system in one embodiment of a content management system according to the invention to provide a data structure that allows PCOs and their associated metadata to be stored in a manner which allows management tasks according to the invention to be performed on the PCOs. Accordingly, this table entity may provide a single “entry point” to all existing assignments, projects, associations, budgets etc., thereby supporting system users in performing required management tasks on the PCOs during any production workflow of a news publishing product. The simple and exemplary Assignment table defines three assignments, each having a unique assignment identifier, 001, 002 and 003, respectively and corresponding slugs HOTELFIRE, HOTELFIRE and HOMERUN: Each of the assignments is related to a corresponding story covering a particular news event or certain aspects of the news event.

Each of the assignments in the Assignment table has five metadata fields holding information describing the PCOs associated with the assignment Furthermore, the Product link table comprises ten additional metadata fields for each of the assignments 001 and 003. These ten metadata fields store information about or relating to a target publishing product in which the associated PCO is planned for publication. The type of fields selected for the illustrated Product link table could be relevant for publication of a PCO in a newspaper product, e.g. a newspaper name (Morning Star), a publication date, an edition, a zone, a budget, a page placement. The Budget fields of the Product link table also illustrate how assignments may be put on budgets and the budget information subsequently stored in the database system. Since any assignment may exist on several budgets and any particular budget typically comprises several different assignments, the Product link table is utilized by the content management system to keep track of relationships between budgets and assignments.

In the Assignment table, the Assign_ID metadata field of the first assignment stores a unique ID number, 001, of the assignment, the second field stores a short descriptive name or slug, HOTELFIRE, of the assignment. The third field. the Origination field, stores information about the person and/or desk responsible for creating the assignment. in this example a name of e.g. an assignment editor or reporter. The fourth field stores information about the data type of the PCO associated with the assignment and the fifth field stores information relating to the current status of the PCO on a suitable pre-determined scale, e.g. planned, in progress, completed, released etc. as illustrated. The sixth column does not represent a set of metadata fields, but represents the stored PCOs.

Each of the fields in this column may directly store a generic lump of “publishable” data or data entity representing the PCO of the assignment. Alternatively, this field may store a data pointer to the data representing the PCO, thereby redirecting the system to access a relevant storage address.

The Project mapping table illustrates how the present content management system may utilize the unique assignment identifier provided for each assignment in the Assignment table to organize a number of related assignments into projects. A project typically covers a larger news event or subject that may generate many related assignments. The project KOSOVO shown here, merely provides an illustrative example of the potential number of assignments that a Project mapping table must be able to handle.

The Association mapping table illustrates how the present content management system may utilize the unique assignment identifier provided for each assignment to group assignments into associations. These association may be introduced either to keep track of multiple related assignments while covering a single news event, or for the sole purpose of creating topical relationships between otherwise unrelated assignments. Each association comprises two or more assignment which in the present embodiment of the invention are identified as members of an association by means of their unique ID numbers. Each assignment that participates in an association is further provided. with an Association Category metadata field which holds information about the role of the assignment in the association. Any assignment may participate in several associations, as illustrated for Assign_ID 001 in the Association table. 001 is the main story of association A1 and participates in assignment A3 because it is topically related to the main story of association A3.

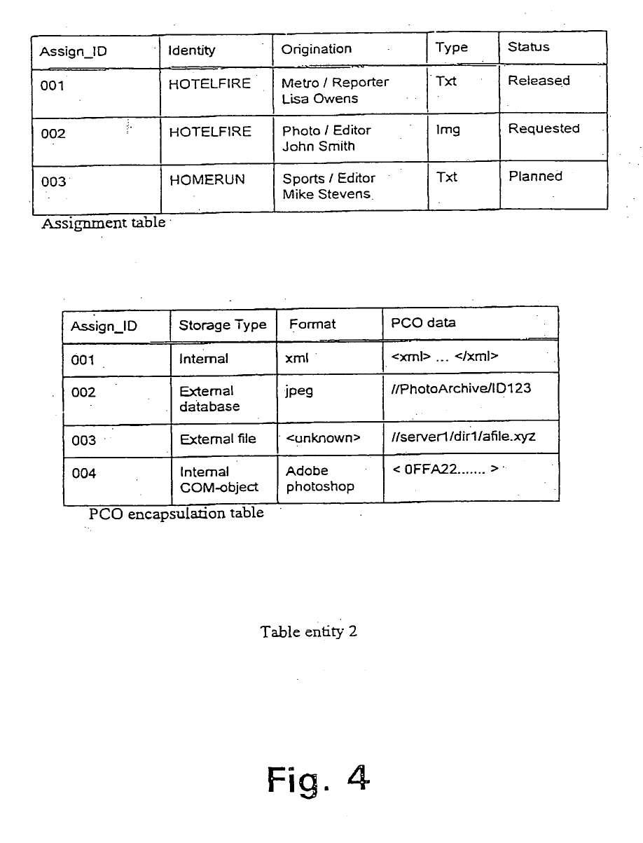

FIG. 4 of the drawings is an exemplary illustration of an alternative table entity which in another embodiment of the invention may replace the functionality provided by the Assignment table of FIG. 3. The table entity of FIG. 4 comprises two tables, an Assignment table and a PCO encapsulation table. The PCO data field in the original Assignment table of FIG. 3 is replaced with several fields in the PCO encapsulation table, thereby providing additional information about the format and storage of the actual PCO data, and at the same time keeping this information separate from metadata stored in the Assignment table. The additional information shown in this exemplary embodiment of the PCO encapsulation table are such data as might be required to hold PCO data of any format, and stored either internally within the database itself or in an external database or file system file. By utilizing the unique assignment ID as a PCO encapsulation table entry point, the PCO data associated with an assignment can be located without concern for the format or physical storage location of the actual PCO data.

This embodiment has the advantage of effectively encapsulating PCOs of different formats, and stored either internally or externally, thereby allowing such diverse types of PCOs to be accessed uniformly through the unique assignment ID. It further has the advantage of allowing multiple PCOs to be associated with the same assignment metadata simply by allowing multiple PCOs to be listed in the PCO encapsulation table with the same assignment ID in the Assign ID field. This effectively addresses the requirement for certain assignments to spawn multiple PCOs, that all share the same assignment metadata.

The Storage Type field in the second column of the PCO encapsulation table holds, for each PCO, information about the physical location of the relevant PCO (internal or external) as well as a classification of its type of storage (database, file, COM-object, etc). The Format field in the third column of the PCO encapsulation table hold, for each PCO, information about the format of the actual PCO data. This can either be a format known to the content management system, thereby allowing it to interpret, and act on those data (display, edit, etc), or it can be an unknown format, in which case the system will rely on other software installed on the workstation to act on the PCO data.

The PCO data field may either directly store a “lump” of data (in database terminology referred to as LOB (Large Object) or BLOB (Binary Large Object)) representing the actual PCO data itself, as illustrated for assignment ID 001 and ID 004 or, alternatively, as illustrated for assignment ID 002 and ID 003, pipe the system access to the relevant external storage address, in this case //PhotoArchive/ID123 (to designate storage in another database system) and//server1/dir1/afile.xyz (to designate storage in a network server file).

It will be understood that in most embodiments, a number of additional fields are further required in the PCO encapsulation table in order to store other relevant information about each PCO.

### DETAILED DESCRIPTION OF EMBODIMENTS

In the following, various specific embodiments of the invention are discussed in greater detail. It will be understood, and will be realized by the person skilled in the art, that the invention is not limited to this embodiment, and that the individual features of the content management system described herein could be implemented in many other ways and combined with the above-described features.

Technology

A content management computer system according to a preferred embodiment of the present invention is based on an open architecture running in a client/server environment. This architecture reduces the load on a PCO database and guarantees a quick response time for the end users or operators.

The core of the system is an Oracle SQL database running on high availability AIX or UNIX servers with mirrored disks. The database may comprise all PCOs and associated metadata grouped into a, typically, very large number of assignments as well as various administrative information.

Client workstations are preferably personal computers (PCs) running operating systems such as Windows NT, Windows 95, Windows 98, Linux, etc. From a client workstation the user can access all relevant applications (i.e. a single footprint environment). It is presently preferred that the client workstations are using Windows NT as an operating system, which provides the users with access to a variety of standard desktop applications such as e-mail, web browser, calendars, etc.

All hardware and software utilized in the system are operating according to respective industry de facto standards, such as UNIX servers from IBM and Sun Microsystems, Oracle SQL database, and Windows NT PCs.

Software modules implementing the present content management system are, preferably, written in C and C++, and have graphical user interfaces based on industry standards such as Windows NT, thus as much as possible relying on intuitive and familiar Windows concepts and user interface elements.

The system comprises a number of software modules each implementing a specific function or functions within the present content management system. The functions and features provided by these software modules are explained and described in the following paragraphs.

Describing the PCOs with Metadata

Metadata are defined as “data about the data”, rather than the data itself. They are preferably implemented as additional database fields on PCOs used to document, describe and categorize these objects so as to allow easier browsing, tracking, searching and retrieval of the stored contents. Examples of important metadata fields are: Slug, Editor, Author, Abstract, Ranking.

Categories and Keywords.

In the present database system. metadata are the very key to managing and sharing publishing contents in the form of PCOs or content objects. Metadata are essentially the “wrapping” around substantially each content object that allows users to evaluate what is “inside the package” (i.e. the content object or body), without having to actually open, study and “digest” that content body. Besides, allowing content objects to be described for purposes of planning, organizing, tracking and retrieval within the content management system, metadata are also crucial in promoting the publishing contents broadly through syndication and wire and even to end users—and hence one of the most important means for increasing the value of content assets.

What's in an Assignment

Preferably, an assignment comprises one or several PCOs and a number of different metadata fields, such as fields related to:

Slug. Descriptive assignment name, usually all caps. This name is referred to constantly when the story is discussed among editors, between editor and reporter and at news meetings.

Originating assignment editor. By default the logged in user creating the assignment, but editable, in case an assignment is entered from someone else's workstation or on someone else's behalf

Originating newsroom, desk and sub-desk. These fields are preferably filled out automatically based on Originating assignment editor, but may still be editable, in case one editor temporarily steps in for another or is managing several desks.

Type. The type of copy under this assignment: Text, Photo, Graphic, EPS, Radio broadcast, Video clip, etc. Default based on Originating assignment editor (or possibly his/her desk).

Abstract. Short description of story (but longer than 255 characters!). The abstract is updated as the story develops.

Keywords. Comma-separated keywords categorizing the assignment. This can be used for subsequent sorting and grouping of assignments. Keyword fields tend to be ignored by users, but can be very powerful if used consistently.

Author. The user (reporter, photographer, graphics artist, etc) which is the primary author on this assignment (but not usually the one who enters the assignment, as that is done by the assignment editor). Any number of users can edit an assignment over the course of its existence, and their names will be recorded in the Modification Log, but this field records to whom it is currently assigned.

Budgeted Size. The estimated size of the assignment's content. In inches, lines or columns for a paper. In minutes and seconds for a broadcast. In characters (or whatever) for an online product

Deadline. In case the deadline for this specific assignment is different from the general deadlines defined for the product.

Target product. The product for which this assignment is intended and which also defines which budgets can be selected for the assignment. Default based on Originating assignment editor (or possibly his/her desk).

Budget and sub-budget. The budget (and optionally sub-budget) on which to put this assignment. A budget usually (but not always) reflects a section of the product. If a Publications date/time is specified, only budgets defined to run on that date can be selected.

Publication date/time. The date and optionally the time of the publication (or broadcast), for which this story is intended. If a Budget has already been selected, only dates/times when this budget is defined to run can be selected. This field can be left blank for assignments that still do not have a firm publication date. Also, it can be set to Always, which means the assignment is targeted for publication every time its budget runs.

Zones. If a budget is defined as zoned, the assignment can be put specifically on (or off) individual zones of that budget. This will allow zoned versions of the story to be stored under the same assignment. If no zone is specified, the story will go unchanged in all zones of that budget.

Edition. An assignment can be targeted for a specific edition (if the editor knows it will not be ready by earlier edition deadlines). This way, it will only be included in budgets for that edition and later editions. If separate Zones are specified, Edition can optionally be specified for each individual zone.

Ranking. Determines how prominent a position the assignment should have. Possible rankings could be: A1, A2, Section front, Inside section, Filler, Keep, Kept and Discard, but the list of rankings is configurable. Assignment editors suggest rankings, but stories can be promoted or demoted during the day. This field can of course also be used to group and sort stories based on ranking. If separate Zones are specified, Ranking can be specified for each individual zone.

Alternate Budget and sub-budget. An optional and purely informational field to record another budget (and optionally sub-budget) for this assignment, in case it does not get played in its preferred budget.

Candidate for. A list of the other products, for which this assignment is a candidate. This can be used by assignment editors to tell fellow editors in other newsrooms to consider this assignment. Of course they can still use the assignment regardless of this field—it is only a means for assignment editors to “pitch” their best stories for broader distribution.

State. Built-in and user-defined states. In particular, it keeps track of the underlying content—i.e. whether the assignment is only a planned one, is actually assigned to someone, is currently being edited, or released for publication. Various actions can be triggered when an assignment reaches a certain state.

Visibility scope. Levels of visibility scope—i.e. who should be able to see this assignment Current levels are: Me only, My desk only, This newsroom only, All newsrooms, but of course these levels can be configured. Default should be: All newsrooms, but that too is of course configurable.

Access scope. Levels of access scope—i.e. who should be able to use the contents of this assignment. Current levels are the same as for: Visibility scope and the default is for: Access scope to be the same as: Visibility scope.

Defer external access until. This field allows simple criteria-based embargoes to be enforced on assignments by deferring access to their contents until either a specific date/time or a specific State has been reached or a combination of the two (such as “12 hours after Release State has been reached”). This field only limits access from outside the Origination newsroom and only applies if these newsrooms are within the assignment's Visibility and Access scope.

User-defined database fields are also allowed to be defined according to the present embodiment of the invention, such as:

Must run today—or the story will be irrelevant.

Questionable—if the story still needs verification or may not be ready before deadline.

Notes. Any notes from the assignment editor or reporter about the assignment, its placement, any potential risks in running this story, anything. This is different from the abstract, which only describes the story itself.

Modification Log. A sort of dynamic notes field where each entry is stamped with date/time and user name. When editors and reporters edit an assignment, they can add comments here on what they were doing and why. Machine generated texts provide simple log entries wherever possible.

In addition to these fields, the attributes or fields of the underlying PCOs also apply to the assignment this is advantageous since users then do not have to deal directly with the PCOs, as described later. Other fields may also be included to support other already existing media as well as future electronic media. All this cross-media, multi-candidate, budget-assisting functionality requires a large number metadata fields to be filled out. However, it does pay back in terms of savings when updating budgets and organizing one's contents. It is of course important that the present system supports an extremely easy way to enter and maintain assignments. According to the invention, this has been achieved by means of default field values and auto fill-outs (based on other fields), requiring only a minimal number of keystrokes for the bulk of assignments (except for the abstract, of course).

The Assignment Pool

Preferably, all assignments are stored in one great, big assignment pool covering all newsrooms, products and desks. By filtering on: Origination newsroom, desk and sub-desk fields or Target Product, Publication date/time, Budget, Zone and Candidate for fields, editors in different newsrooms and at different desks see only what they want to see (and are allowed to see).

Managing Metadata Fields

The present content management system allows any number of metadata fields to be added on content objects. All standard field types (text, integer, float, yes/no, date/time etc) are supported as well as certain specialized fields.

Adding, Changing and Removing Metadata Fields

The exact metadata fields required may change as new products are added or discontinued, new processes included or other changes in workflow occur. Hence the actions of adding, changing and removing standard types of metadata fields are sufficiently easy to be performed by system administrators without having to consult with the support department of the present applicant.

Indexing Metadata Fields

While some metadata fields are used only for informational display purposes, other fields are used heavily for sorting and filtering, and some also for word-based full text searches among tens (or even hundreds) of thousands of content objects. In order to ensure acceptable performance on these operations, system administrators may define whether individual metadata fields are indexed (for fast filtering and sorting), and if fields are included in full text indexes (for full text searching).

Special Metadata Field Functionality

Most metadata fields are standard field types and require no specialized functionality. Their purpose is simply to “be there” to document the contents and for efficient filtering, sorting, searching and tracking. A few fields, however, require special functionality:

Slug Fields

Slugs are descriptive names of PCOs. As such they are no different from any other text field, except there are certain requirements on their uniqueness. Specifically, no two content objects of the same type can have the same slug in order to avoid confusion when stories are discussed among users and at news meetings. However, content objects of different types can have the same slug. Also, content objects originating from different newsrooms are, preferably, allowed to have the same slug.

Long, Formatted Text Fields

The present system provides text fields longer than the commonly utilized 255 characters for certain purposes such as Abstracts (brief descriptions of content objects, allowing users to get an overall understanding of a story without having to read the full text of it) and Assignment Instructions (detailed instructions to reporters, photographers and graphics artists). These fields provides simple formatting (line breaks, bold and italic). It is also possible to edit them in Word (e.g. to assist copying text from the story itself) as well as in a text field on an entry form or in a Mosaic window. It should also be possible to display them in Mosaic windows for read-only purposes, requiring a separate mouse click or keystroke to lock them for editing. These fields will be indexed for full-text searches, however they will not be used for sorting and filtering.

Keyword Fields

Keyword fields contain one or several keywords describing the subjects of content objects. They are presented as a string of comma (or semicolon) separated words on entry forms and in list windows. Ideally, keyword fields can either be filled out by typing the keywords directly (separated by commas or semicolons) or by selecting them from a list of pre-defined keywords. The system can be configured to disallow the use of keywords not contained in the pre-defined list. Full-text search for content objects with specific keywords is required. Fast filtering and sorting on keywords is also required. If content objects contain multiple keywords, they will be displayed multiple times in list windows that include the keyword field. Note that this is a field type and several such fields can exist on content objects. For example, one could have a field named Category where experienced librarians enter keywords from a pre-defined list as well as a general field named Keywords where reporters and editors themselves enter any words they feel describe the content object.

Modification Log Fields

Modification log fields help keep track of changes made to content objects. They are basically note fields, except that note entries are automatically appended whenever someone edits the content object. The User ID and a time stamp are recorded together with a machine generated text describing the editing action (e.g. “created object”, “edited content” etc). The user can modify this text with a more meaningful description of what changes were made and why. This is not the same as Audit Trail, which tracks database actions for administrative and statistical purposes. This field stays with the content object and documents how it has developed over the course of its existence.

Access Fields

These fields describe on the level of individual content objects which users inside and outside the organization can access contents—and when such access is allowed. These fields require little client side functionality, but of course they affect the backend database that enforces the access restrictions.

Product Link Fields

Product link fields comprise the links that include a content object in a publishing product. Exactly which fields make up a complete link depends on the type of product. These fields require no special client side functionality, but of course their setting will affect the products involved. From a content management perspective, the most important use of Product link fields is for “budgeting” contents for each product..

Entering and Editing Metadata

Metadata fields are entered and edited either through entry forms or directly in list windows. Maintaining a content management system like this requires an unfortunate abundance of fields. Yet, entering and editing these fields is extremely easy and user friendly. Specifically:

Rich, Customizable Entry Forms

A rich forms environment is required, allowing forms with familiar Windows user interface elements like button bars, status bars, custom menus and tab panels as well as familiar control types like combo-boxes, list boxes and option groups. The design environment is sufficiently solid and intuitive that system administrators are capable of designing these forms without having to consult with the present applicant. All fields that can be included in list windows can also be displayed in entry forms. Most of these fields can be edited directly in the form, but needless to say, others are “display only” and can only be edited by actions or implicit database commands.

Different Entry Forms for Different Content Types and States

It is possible to design different forms for different types of content and for different states of a given type. For example, photos have fields pertaining specifically to photo requests and photo assignments (i.e. the task of sending a photographer someplace to shoot a series of photos). The entry form for this will be different from the form used to describe photos once they are stored in the system (even though both forms deal with photo objects), and of course both will be different from the entry form used to enter metadata on text objects.

Default Values

It is possible to define default field values based on the logged in user. That includes all of the Origination fields and Access fields and most of the other fields. These default values can be defined by system administrators without having to consult with the present applicant, and may be used whenever new objects are entered.

Automatic Look-Up Values

Wherever possible, field values that can be derived from other field values already entered are filled in automatically. Of course users can override these values, but preferably they shouldn't have to in most cases. Like default values, the rules for these look-ups can be defined by system administrators without having to consult with the present applicant.

Combo-Boxes with Auto-Complete

Most fields contain values from pre-defined lists (lists of desks, lists of products, lists of zones, etc). Combo-boxes with “auto-completion” allow users to either select an object from a drop-down list or have the system pick a matching object based on the first few letters typed.

Keep Form Open

It is possible for users to browse through content objects in the entry form without having to open and close the form repeatedly. This includes actions in the form to move to the previous or the next object in the list window from which the form was opened, or to simply click another object in that list window (while the form is still open) and have that object displayed in the form.

Buttons and Keyboard Shortcuts for All Related Commands

When a content object is open in a form, there is buttons on the form to easily invoke all actions relating to that object. Examples are Edit Content (to open the content in Word, PhotoShop etc), Assign to Author (to save the object and send it to the User Basket specified in the Author field), Request photo (to link a photo or photo request to the story). Also, there must be equivalent keyboard shortcuts for all of these actions.

Editing Fields in List Windows

Having to always open an entry form in order to edit metadata can be cumbersome, and the ability to edit fields directly in list windows is a highly prioritized requirement as well. Like entry forms, the design of such list windows is simple enough that it can be performed by system administrators without having to consult with the present applicant. Most of the control types available in entry forms (combo-boxes, drop-down list boxes, checkboxes etc) can also be used in list windows. Similarly, default values (as previously described) and auto look-up rules (as previously described) can be defined for fields in list windows.

Browsing Content Objects and their Metadata

Content objects are stored in one great big database pool, accessible by all users in all co-operating newsrooms (given proper access permissions, of course). By means of filtering, users see only the objects they need and want to see at a given time, and they can search for objects using the metadata fields. Any metadata field can be included as a column in list windows, and customized views can be defined for all types and groups of users and adjusted by these users themselves.

Viewing and Editing Abstracts and Other Long Text Fields in List Windows

Because of the importance Abstract fields when perusing lists of stories, users need some means of displaying and editing those fields inside list windows without having to open a form. Of course this requirement also applies to other long text fields that might be used, such as Assignment Instructions.

There exist two options:

To display abstracts for all objects in a list window as a variable number of full-width lines below a normal DBA-row of attribute fields. This resembles the layout of traditional budget files and allows the fastest browsing of many stories. Which attribute fields to include in the row above the abstract is defined within the list window presentation as usual.

To display abstracts in a separate part of the list window similar to the Mosaic window. This requires users to select a story in order to read its abstract, which is somewhat less efficient, but preferable in some cases because it retains the consistent one-line structure of lists.

Icons and Colors to Identify Content Objects

In order to assist users when browsing thousands and thousands of content objects, it is possible for system administrators to define icons and colors for different combinations of content types and other field values. Specifically, icon columns can be added to list windows, mapping field values to icons (e.g. to identify content types) and rules can be defined for mapping combinations of fields values to different colors.

Dynamically Updateable List Windows

Dynamic updates of list windows as hundreds (conceivably thousands) of users in different newsrooms are entering new content objects and updating metadata will become far, far more important in this environment, and be used by most if not all users. Performance is of course an issue here and will have to be addressed, whether by use of broadcasting, consolidation of multiple updates or other techniques.

Locking Metadata and Content Body Independently

It is quite possible and perfectly valid for two different users to update the metadata and the content body of an object simultaneously. E.g. if an assignment editor updates the Abstract and other fields of a story to prepare it for an upcoming news meeting while the reporter is writing on the story itself. Hence, the two are locked independently.

Automatic and “Assisted” Metadata Generation

The importance of rich and appropriate metadata can not be emphasized too much. Yet filling out the many metadata fields should not be a nuisance to users—a contradiction if there ever was one! Any metadata fields are whenever possible derived or generated automatically. Examples of this are:

Generating “synthetic” default abstracts based on existing text content.

Extracting default keywords based on text content.

Suggesting relationships with other content objects.

Advanced algorithms for these tasks are constantly devised and refined by other database sectors such as those of digital libraries and data warehousing.

Other techniques are:

Gradually entering field values as required steps in the workflow.

Duplicating field values from closely related content objects e.g. from the main story to a sidebar.

Such automatically generated values are used even if only as defaults that will be overridden in most cases, as the alternative will often be no values at all.

Exporting Metadata

In order to promote editorial content as broadly as possible, the content management system has the ability to export metadata separately (i.e. without content bodies) into user-defined file formats. This exportation can either be on an individual basis or (commonly) based on automation rules.

Metadata for All Types of Content

The present content management system is used as the administrative repository for all conceivable types of contents, including contents not directly supported by associated or integrated production systems, whose content bodies may be held entirely outside the present database. For such products and contents, the content management system stores metadata and pointers to the actual contents (say, record ID or tape ID and index position), thereby allowing all content management (e.g. tracking, searching, assignment management, editorial budgeting) to take place in the same environment for all publishing products and media.

Organizing Content Objects by Relating them to Each Other

When users in several newsrooms, working on several products, begin to share thousands of content objects every day, they need ways of communicating to each other. when content objects are related somehow. The content management system must include features to record and view such relationships.

Grouping on Shared Field Values

Views in list windows can be set up to group content objects based on field values. Whenever several content objects share the same value in a grouped field, they will be grouped together and collapsed under a group heading. For example, grouping on the Desk field will display a group heading for each Desk, and collapse all content objects under their respective Desk headings. By expanding the header for, say, the Foreign desk, all Foreign stories will become visible under that header, while stories from other desks remain collapsed under their respective group headings. This makes it possible for users to browse a huge number of objects without being overwhelmed or scrolling endlessly.

In effect, grouping on a field value is simply sorting on that field combined with the ability to selective hide and unhide objects with the same value in the sort field. A special case here is grouping on Keywords, which will create group headings for each keyword and display all content objects containing that keyword under their respective headings. Content objects with more than one keyword will appear several times in the list window, under each of their keyword headings.

Grouping Content Objects into Projects and Sub-Projects

To support multiple stories covering a single news event—possibly across several products and newsrooms—content objects can be grouped together as projects and browsed hierarchically. The user can then expand the project to list the objects belonging to it. Project relationships are easy to establish and maintain (say, with drag & drop to add objects to a project) Each object can belong to any number of projects. If an object belongs to more than one project, it will be displayed several times in the same list window, under each of the project headings to which it belongs.

Sub-Projects

Projects can be nested inside each other (i.e. as sub-projects), thereby allowing logical ways of organizing contents for large news events.

Inheritable Metadata Fields on Projects

In order to include content objects in a project, the project has to be created and given a name. Also, other fields can be added to projects, further describing their purpose or any other information pertaining to them. Content objects belonging to a project can include these “project metadata fields” in entry forms and list windows. Another project requirement is the ability to define default metadata field values for new content objects added to that project. These defaults will override other defaults defined for individual users. Typical applications of this would be to include default keywords on all content objects created as part of a project or, to put those objects on a specific budget instead of the default budget for that user.

Grouping Content Objects with Associations

The means described above for relating content objects do not meet all the requirements in a content management environment. Specifically, the former relies on existing field values, and the latter requires projects to be created as separate entities. Other, less rigid relationships are required as well. We need to associate content objects with each for the sole purpose of creating topical relationships, even between objects that are not necessarily packaged into the same physical article. For the remainder of this document, we shall refer to such relationships as Associations, because they associate content objects with each other for a number of different purposes, such as:

Associating Stories with Photos or Graphics

Assignment editors and reporters need to link existing photos or graphics to a story or create requests for photos or graphics to be created. In either case, the resulting photo(s) or graphic(s) should be associated with the story. Such associations can be used to later form articles in print or online products.

Associating Related Stories

Otherwise unrelated stories (say, that do not already belong to the same project) can be associated if they touch on the same subject, cover different aspects of a story, quote the same people—or for whatever other reason editors and reporters see fit. Such associations may—or may not—cause the stories to be packaged when they are published, or they may be used to generate hyperlinks in online products.

Associating Wires with Stories

When a wire is used in a story, an association is created, allowing users looking at the story to see which wire was used and, even more importantly, allowing users looking at wires to see in which story a wired has been used. If multiple wires are used in a single story (such as for digests) they all belong to the same association.

Basic Association Requirements

These requirements are best addressed by allowing content objects to be members of one or several “families” or, as we shall call them, Associations of related objects. Associations could be considered ad hoc projects, because they do not have visible names and they are created on the fly whenever objects are associated with each other.

The most basic properties of associations are:

The ability to easily create and update relationships between two or more content objects.

The ability from any content object to easily display all related objects.

The ability for each content object to participate in any number of associations.

Creating and Updating Associations

Associations can be created by selecting two or more content objects and invoking a Create Association command. Additional objects can be added to the association simply by dragging and dropping them on any content object already included in that association.

Viewing Associations

When content objects are displayed in list windows, it is preferred to display their associated objects either hierarchically or in a separate Associations sub-window (similar to the Mosaic window). When content objects are displayed in entry forms, it is preferred to display their associated objects in a separate Associations sub-window within the form. In list windows, associated objects can be displayed under each of their “associates”. In other words; if three objects are associated, selecting either of them will show the other two—either by expanding a hierarchically indented list or in the Associations window. In cases where associated objects themselves are associated with yet other objects (i.e. participate in another association), an association tree is formed and can be viewed either hierarchically indented or in a separate list window.

Association Categories

Because there are a number of different reasons why content objects might be associated, users need a way to describe for each content object how or why it belongs to an association. This is addressed by adding an extra field to describe the Association category of each content object belonging to the association. Whenever a content object is added to an association, an Association category is recorded as well. If an object is a member of several different associations (because it is related to several otherwise unrelated objects), an Association category is recorded for each membership.

The present embodiment of the content management system supports the following Association categories:

Main Story

Signifies that this object is the main story of the association. The association may contain several main stories as long as they target different products.

Article Element

Signifies that this object will be part of an article in a specific product comprising the main story as well as all article element objects within the association.

Sidebar

Signifies that this object will be published close to the main article, but is not part of the article itself. It might very well be an article element in another association, in case the sidebar is itself an article comprising several elements.

Same Topic

Signifies that this object primarily covers the same topic as the main story, but is not (necessarily) to be published in the same article—or even in the same product.

Touches on Topic

Signifies that this object touches on the same topic as the main story, but that it is not the main topic of this object.

Same People

Signifies that this object mentions or quotes the same people as the main story.

There is no functionality as such attached to the various categories—they exist only for informational purposes. However, it is absolutely possible to use these categories to perform certain actions like automatic creation of product specific packaging.

Association Categories Ordered by “Tightness”

The present system also provides the possibility of defining a “tightness order” for Association categories so that content objects can be sorted by how tightly they are associated. The list of categories is:

Main story

Article element

Sidebar

Same topic

Touches on topic

Same people

This way, objects that belong in the same article would be listed closer to the main story than objects that are only topically related.

Creating Articles and Links from Associated Content Objects

If Associations are used consistently, content objects will be related to each other in associations before articles are created. As a powerful aid for layout editors, it is possible to pick objects in list windows and create an article from them. Often it will be the top-most objects within an association since they are the most tightly associated, and hence the most likely candidates for an article. But in addition to this aid in creating packages manually, it should also be possible to automatically generate articles and hyperlinks based on their “association tightness” (i.e. the Association category). Particularly for online products, this is an extremely simple and powerful way to maintain links between stories. Maintaining simple hyperlinks from one story to another can be a highly complicated and cumbersome task and is greatly simplified by the use of associations.

Associating External Objects with Contents

Associating content objects with each other is fine, but often, other information go into the research and creation of a story, such as World Wide Web pages, spreadsheet or database files, references to old stones or links to contacts and sources in a GroupWare system. The possibilities of storing such external content objects in the database and associating them with stories or projects is one major advantage of the present content management system. Accordingly, such objects may be stored and thus included in associations and projects as transparently as native content objects. This concept is referred to as the “Bucket concept”, where each assignment becomes a bucket into which all related objects are thrown for later retrieval.

Browsing Related Contents

Needless to say, the whole idea of recording various relationships between content objects is to allow such relationships to be viewed later, when browsing these objects. In present content management system provides several possible ways of viewing these relationships:

Hierarchical, Collapsible/Expandable Outline Views in List Windows

Hierarchical, Windows-style, collapsible/expandable outline views can be used to display relationships between objects. Whenever an object in a list window has other objects related to it, it can be expanded, thereby revealing those related objects as indented lines below the original object. If those objects again have other objects related to them, they can be expanded as well, revealing a second level, and so forth.

Displaying Related Objects in a Second List Window

When a content object is selected in a list window, a second list window can be opened to display the entire hierarchy of objects that are related to it. This feature has the benefit of displaying objects that are higher up in the hierarchy than the “root” level of the original list window.

Easily Identifying Content Objects with Relationships

To save users from having to click or expand a content object in order to see if it has any related objects, an icon or other form of identification is required telling users which content objects have relationships.

Assignments: Managing Planned-Only Contents

Content objects often start their life long before any piece of the actual content is created. First, as entries in calendars of news events (the Sports desk, for example, maintains a list of games to cover). Later, metadata fields will be filled out and the task of creating the content may be assigned to a reporter, photographer, graphics artist or an entire team. Hence the term assignment. For lack of a better term, and in line with common newsroom jargon, we provide the following definition of an assignment: An assignment is a description of a piece of copy (story, photo, graphic, video or other) and the data representing the piece of copy, whether that copy is only planned, is actually delegated to someone for creation/editing, or is already available as content. The present system is able to create and manage assignments in the form of empty content objects as placeholders for metadata.

Dedicated Assignment-Fields

As the term implies assignments are used (among other things) to describe and manage the delegation of content creation to individual reporters, photographers, graphics artists or entire teams. To facilitate this, additional fields can be added, depending on the type of the content. For example, photo assignments may include a number of fields such as: Location, Contacts, Appointments, Focus and Reporter there? These will all be ordinary metadata fields that do not have any special functionality built into them. They may exist on all photo objects, but are only included in presentations and forms for some users.(the Photo Editor, for example).

Entering and Editing Assignments

The content management system makes no distinction between assignments (i.e. “empty content objects”) and any other content objects. Thus assignments can be entered and edited using the same metadata entry form as is used to maintain metadata on content objects in general. However, for some types of PCOs it may be desirable with dedicated assignment entry forms displaying only assignment-specific fields, such as those mentioned above for photo assignments, and possibly excluding other fields that only become relevant later as the assignment matures into “real” content Thus it is possible to define which forms to use, not just based on content type, but also based on the value of the State field describing the “maturity” of an assignment.

“Intelligent” Detection of “Similar” Assignments

A very common problem even for a “stand-alone” newsroom, is that of different users initiating stories for the same or a largely overlapping news event. This issue is severely exacerbated once several disparate newsrooms start creating contents in a shared environment, and accordingly also addressed in the present content management system. In broad terms, when new assignments are entered, their abstracts and keywords may be matched against objects already in the assignment pool, looking for apparently similar objects. By presenting the user with a list of matching objects, he or she can determine if this story is already being covered (in which case maybe the assignment should be discarded all together) or if the matching objects are simply related (in which case relationships can be formed)—or maybe there is no real overlap, in which case the user can simple proceed with the new assignment. Of course such methods will not be able to determine with absolute precision if two abstracts describe the same story, and the result of these searches will only be suggested to the user for further evaluation—not for the system to single-handedly force relationships or take other actions.

Multiple Content Objects Under a Single Assignment

Some assignments generate several content objects that all refer to the same original assignment. The best example of this might be photo assignments where photographers bring in several photos from the scene. Such content objects can be brought into the database and linked to the original assignment. Also, the metadata field values of the original assignment can either be copied or inherited by the individual photos.

Using Assignments as Calendar Entries (Pre-Assignments)

Assignments can be entered weeks, months or even years before the content creation actually starts. These “pre-assignments” can replace the news event calendars maintained by most desks, with the benefit of being the very same objects that mature into actual assignments and later into real content objects. Through the remainder of this document, “pre-assignment” is defined as “using metadata fields of content objects to describe future news events to be covered”. Pre-assignments can be distinguished from other assignments (and other content objects in general) either by the value of their State field or by a separate field tagging them as pre-assignments. The following features assist the use of the content management system for managing pre-assignments:

Dedicated Pre-Assignment Fields

It might be useful to create fields that are dedicated to describing pre-assignments. This includes (but is not limited to):

The date/time and duration of the event.

Description of the event (other fields such as Abstract could be used, but would then be overwritten later when an actual abstract is entered).

Information about contact persons at the event.

Date/time to be reminded of the event. A notification message can be send to selected users in advance of the event.

Dedicated Pre-Assignment List Windows

Dedicated views in list windows, filtering to display only pre-assignments and including the above mentioned pre-assignment fields, will form an effective tool for maintaining large lists of news events to be covered. Needless to say, such presentations can be limited to desks.

Dedicated Pre-Assignment Entry Forms

To save users from having to deal with all the other metadata fields, a dedicated entry form can be created, containing only those fields pertaining to pre-assignments. Together with the dedicated list windows, such a form could completely eliminate any visual indication that pre-assignments are really “immature” assignments which again are immature content object.

Assignments for all Types of Content

The present content management system allows assignments for all conceivable types of content to be created, maintained, routed, tracked and managed. This is not limited to content types known and supported by production systems delivered by the present applicant, but also includes other media and content types—even if the physical content bodies are stored somewhere else (in other databases, on tape, etc). For such products and contents, the present system holds the metadata and pointers to the actual contents (say, record ID or tape ID and index position), thereby allowing assignments to be managed in the same environment for all products and media. The purpose here is to use content management system as the central administrative repository for all contents, regardless of the media type.

Editorial Budgeting

Editorial Budgeting refers to features that assist the editorial filtering and selection process that determines which contents to publish in a given product, as well as where and how those contents are played in that product. (Note: filtering and selection here refers to the human task performed by editors when they decide which contents to publish—not to be confused with filtering and selecting database objects on a computer screen). Budgeting is really the interface between content management and the production/space planning tasks that deal with configuration and layout of a product. However, budgeting does not itself attempt to be space or layout planning.

How Budgets are Used Today

A budget is simply a list of stories (or other contents) used by editorial staff to keep track of available contents. It includes select metadata fields, such as Slug, Abstract, Reporter, Editor and various abbreviations or symbols indicating if there is a photo or graphic with the story, if it is a front page candidate etc. Today, most North American newspapers use simple text files in their editorial system to store budgets, with established conventions for the layout of each entry. Most newspapers maintain a number of budgets for different purposes. Specifically:

Desk Budgets: Each assignment editor maintains budgets of stories from his or her desk. We call these Desk budgets, although they are also sometimes referred to as

Origination Budgets. Often, separate budgets are maintained for “current” and “upcoming” stories.

Layout Budgets: The news desk usually maintains budgets of stories for each day's paper a week or two ahead. We call these Layout Budgets. Often they are divided into budgets for sections, section fronts, zones and online products. A particularly important budget is A1, listing those stories that are front page candidates. Stories often start in desk budgets, and are later copied to layout budgets when their assignment editors choose to submit them for tomorrow's (or some other day's) paper. Thus, the same stories usually appear in their originating desk budget as well as a layout budget.

The fact that a story is on a layout budget does not guarantee that it will make it in tomorrow's paper—only that it is among the stories to be considered for the paper. These budgets—and particularly the layout budget for tomorrow's paper—are the subject of scrutiny at news meetings during the day, where it is determined which stories to publish on A1 and section fronts—and, indeed, which stories to publish at all.

Budgeting

The ability of the present content management system to add rich metadata to content objects combined with the browsing features of list windows, form a very strong environment for editorial budgeting. Once the metadata that comprise budget entries are recorded as fields on the actual content objects, the need to maintain budgets as text files is completely eliminated. Instead, budgets are simply a matter of filtering for content objects with specific field values. In particular, the concept of Desk budgets is completely replaced by filtering in list windows for contents from a specific desk and, optionally, a given date interval. Hence, there is no such thing as a desk budget in this environment, and the remainder of this section is primarily concerned with layout budgets. Layout budgets are a tool for selecting and filtering contents to be included in a specific issue and edition of a product, and for determining how and where to play those contents. Layout budgets form a topical partitioning of the product by dividing it into logical units—which may or may not reflect physical sections—and designating a budget name to each such unit. By associating a story with a specific budget, it is submitted for approximate positioning within the product, even though its exact position and layout—or indeed, whether it will be played at all—has not yet been determined. That is the essence of editorial budgeting in the present content management system, and the remainder of this section describes the requirements to the functions and features of the budgeting mechanism.

Using the Budget Field of Product Links

In the content management system, content objects are included in a publishing product by means of Product link fields specifying details such as Product, Publication date, Zone, Edition, Page, Shape and other product specific information. Each set of Product link fields comprises a link into one product. Several such links (i.e. several sets of Product link fields) can link a content object into several products. The exact fields will vary with the type of product.

All Product link fields do not have to be filled out initially, and only when enough fields (for some products maybe all fields) are filled out will the content object actually find its way into that product.

A content object is submitted for publishing in a product by creating a Product link with the Product, Publication date/time and Budget fields filled out, thereby effectively putting the object on that specific budget of that specific product. By various combinations of filters and grouping, a number of budget presentations can be achieved in list windows and budget printouts.

The fact that a content object is included on a budget does not automatically include it in the product. It merely includes it in list windows and printouts filtering for that budget. Only when all the Product link fields of the link are filled out, is the content object physically included in the product on a specific page, with a specific shape etc.

Adding Contents to and Removing Contents from Budgets

When budgets are maintained as text files, and an entry is simply added to or removed from that file as lines of text, it makes perfect sense to talk about “putting a story on a budget” and “taking it off the budgets”. But in this content management environment, such. wording may seem confusing at first, and indeed, it would be more correct technically to talk about “adding a budget to a content object” because the name of the budget is recorded with the content object, and the budget itself exists only to the extent that any content objects refer to that budget name.

Yet, the net effect is still a budget in the form of a list of stories, which can be perused in list windows or printed out and taken to a news meeting. Therefore, the concepts of “adding to” and “removing from” budgets are maintained with the following definitions:

Adding a content object to a budget means creating a Product link for that object and recording a valid budget name in the Budget field, thereby causing the object tube included whenever that budget is displayed or printed.

Removing a content object from a budget means any action that undoes the above, such as recording another budget name in the Budget field, clearing the field or deleting the Product link all together.

So, regardless of its technical implementation, stories are still “put on” and “taken off” budgets. These actions are accomplished in one of two ways:

By Filling Out Product Link Fields on Entry Forms

Reporters and assignment editors are able to fill out Product link fields directly on entry forms—preferably the same metadata entry form used to enter and edit other metadata fields. This includes the Budget field as well as other Product link fields such as Product, Publication date/time, Zone, Edition, Shape and Page. By entering, modifying or clearing the Budget field in this form, content objects can be added to, moved between or removed from budgets. Needless to say, the values entered are checked against a list of valid budget names.

By Dragging Content Objects to Budget Drop Targets

It is possible to drag content objects to a window listing all budget names. By dropping the object on a specific budget name, it is put on that budget. The list of budget names in the drop target window should dynamically reflect the list of valid budget names.

Additional Budgeting Fields on Product Links

In addition to the Budget field itself, it is possible to add other budgeting related fields to the Product links. Such fields are used to further describe details of how contents are played in each specific product Examples of such fields include:

Ranking

Ranking is used to suggest how prominently a story should be played. It contains one of an enumerated list of values, describing increasing levels of prominence. A possible list of ranking values might be A1, A2, Section front, Inside section and Filler. This field could supplement a Default ranking or Priority field on the actual content object, describing the story's overall importance independently of the products in which it is included.

Suspend (or Approved)

Suspend is a Yes/No field used to temporarily take a content object off a budget, while retaining the information that topically, it belongs on that budget. By changing the Suspend field back to No, the story is immediately back on the budget. By filtering for suspended stories, assignment editors can easily see which of their stories did not make it in today's paper and determine if the stories should be submitted again for tomorrow (simply by changing the Suspend field).

Alternatively, an Approved field could be used with the opposite function, requiring all stories to be specifically approved before they actually appear on budgets. Either approach has merits, or which one to use really depends on preferred newsroom policies.

Sub-Budget

If budgets need to be subdivided into sub-budgets for more granular budgeting, an additional Sub-budget field can be added.

State

Additional, product-specific State fields will be a common tool in managing non-linear workflow for multiple products.

These are only examples of dedicated budget fields. The requirement here is the ability to add any such fields on Product links.

Adding, Changing and Removing Additional Budgeting Fields

The action of adding, changing and removing additional budgeting fields to Product links is easy enough so that it can be performed by super users without having to consult with the system supplier.

Budget Definitions

Before a budget can be used (i.e. before a name can be entered in Budget fields), its name and other information about the budget must be established by means of a Budget definition. Budget Definitions describe the general characteristics of a particular budget and prevent content objects from “disappearing”from budgets due to mistyped budget names or mismatching information. In addition to the budget name, Budget Definitions should contain other information about the budget, such as:

Budget Sort Order

Alphabetical order is not necessarily the preferred order of discussing budgets at news meetings, so some means of determining the sort order of budgets are required.

List of Valid Sub-Budget Names

This will allow the budget to be subdivided into smaller sections, thereby reducing the number of individual budgets to be maintained. This list also determines the sort order in which these sub-budgets are included in printouts and list windows.

Publication Date/Time Pattern

It is possible to define when a given budget runs (e.g. what dates, weekdays or times that section is published), in order to prevent illegal combinations of budget names and Publication date/times from being entered. This may generate actual budget objects (or “instances”) with their own date/time, allowing other information, to be recorded for a specific budget (instance), such as:

Newshole

Available newshole for this budget on that specific Publication date/time. This can be compared against Copy size totals.

Budget Lock Status

To prevent changes from being made to budgets.

Do keep in mind that Budget definitions do not comprise the actual budgets. Rather, they exist mainly in order for assignments to have a budget name to refer to.

Printing Budgets

Of course budgets need to be printed out as well, not just for taking to news meetings but also for individual use by newsroom staff. There are some specific requirements when printing out budgets:

Printing One or All Budgets in One Command

Users need the ability to print individual budgets for a given date of a given product as well as all budgets for that product—without having to first open a list window and select a filter.

Grouping and Sorting Options

Budget printouts have fairly intricate requirements on how entries are grouped and sorted. Just as an example, the format mostly used for news meetings, would print entries with top Ranking (like A1) first, regardless of budget, followed by all remaining entries grouped by budget and sorted by Ranking. In other words, there is great flexibility in determining the grouping and sorting options for budget printouts. The sort order for budgets is established in the Budget Definitions.

Format of Budgets Entries

We want to achieve a budget printout that resembles the way current budgets look. Often this means Slug, Budgeted size, Author, Zones and various custom fields and flags (e.g. Must run and Questionable) printed on the first line, followed by the full text of the abstract on subsequent lines. It is also necessary to be able to mark, if there are any photos or graphics linked to a story. In other words, there is great flexibility in formatting the entries of budget printouts.

Ability to Easily Customize the Printout Format

Because requirements on how budget printouts should be formatted are bound to vary, super users need to be able to define these printouts with fairly easy to use reporting tools, without having to consult with the system supplier.

Copy Size Totals

As a simple aid to assist space management, it is possible to total copy sizes of all content objects on a budget, the total Budgeted size of all content objects as well as Measured size for those objects that have reached a certain State. These totals can then be compared to the Newshole recorded for the budget. This feature is available on-screen as well as in budget printouts. This is by no means intended as a full-fledged space management feature, but as we have the Budgeted size and Measured size fields there anyway, it is advantageous to find the totals.

Locking and Executing Budgets

At some point, a budget for tomorrow's paper (or any other product) will have only those content objects on it that are actually going to make it. All other objects will have been weeded out—either because they were taken off the budget all together, or because their Suspend fields were set to Yes (or their Approved fields are set to No, depending on the chosen model). In other words, the budget is not just a budget anymore, but a real list of stories for tomorrows paper—or more accurately: for the section of tomorrows paper covered by that budget. At this point, we need the ability to perform various global actions, acting on all content objects on the budget as well as the Budget Definition itself As an example, typical actions might be:

Rolling Suspended Content Objects Over to Next Day or Next Edition

Those content objects that have their Suspend field set to Yes (or their Approved field set to No) are moved to next day's or next edition's budget. Next morning, their assignment editors can easily filter for them and determine if they should be re-submitted (simply by changing the Suspend field).

Articles or Online Links Created from Associations

Articles can be created for associated content objects on the same budget (unless they already belong to an article). Similarly, links in online products could be created automatically from the same associations.

Locking Budget

The budget can be locked, preventing other than authorized users—typically on the news desk—from changing content objects on the budget or from adding new objects to the budget.

Other Customized Actions

Any other global actions to be performed on all content objects on the budget. Again, these are only examples of such actions. The requirement here is to allow global actions to be performed on all objects on the budget.

Budgeting for Zoned Products

Because Product links are created for each product or zone that includes a content object, it is possible to budget the object differently in each product or zone.

Budgeting for All Types of Products and Zones

The content management system must allow budgeting for all conceivable types of content and for all kinds of products. This is not limited to content types known and supported by existing production systems, but also includes other media and content types—even if the physical content bodies are stored somewhere else (in other databases, on tape, etc). For such products and contents, the content management system holds the metadata and pointers to the actual contents (say, record ID or tape ID and index position), thereby allowing budgeting in the same environment for all products and media. The purpose here is to use the system as the central administrative repository for all contents and product, regardless of which production system is used.

Managing Access to Content Objects

Because the content management system will serve as central repository for contents from several newsrooms and for several products, possibly allowing external access from a number of participating partners, it is possible to control access to individual content objects by means of access rules.

Access Control on a Content Object Level

Ordinary database rules for access control based on groups of users and classes or pools of contents are simply not sufficiently flexible or granular for the kind of broad use for which the content management system is intended. Although access to most objects will be governed by general newsroom policies, there will always be objects that need different access control for some reason or other. Therefore, access needs to be controlled on the level of individual content objects, rather than by locations within the database or other global information.

Access Scope Expressed as Concentric Circles of Users

Contents will be accessed not just by users within the same newsroom, or within the same building or even within the same organization, but also by various external users such as those from wire services or different publishers buying contents from each other—or even Internet users accessing the archive. Therefore, we need a better approach for expressing access “scope” than just a list of User IDs. One ideal solution would allow access scope to be defined in terms of concentric circles of users such as Me only, My desk only, This newsroom only, All our newsrooms, All partners, Everyone. This would allow finely grained control on individual User lDs for the inner circles and broader control for the outer circles.

Access Fields

Access needs to be managed not just in terms of “who can access an object” and “who can not”, but also in terms of “how much can they access it” and “when”. The required access control can be expressed in terms of the following Access fields.

Visibility Scope

Who can see this content object and its metadata—but not its content body? Default for new assignments might be All our newsrooms, allowing all newsrooms within the organization to see what the other newsrooms are working on. When a content object is released, Visibility scope could be increased to Everyone, promoting the story as broadly as possible without actually allowing it to be used.

Usage Scope

Who can use this content object's body? Usage scope must always promote Visibility scope if necessary, so these users can also see the metadata. Default for new assignments might be All our newsrooms, allowing all newsrooms within the organization to open and use the content body even as it is still being created. However, unlike Visibility scope, Usage scope of released stories might never be increased beyond All our newsrooms or All partners, thus requiring external users to order stories individually.

Defer External Usage Until

When can external users actually use this content object's body? This field allows criteria-based embargoes to be enforced on content objects by deferring the selected Usage scope until either

a specific date/time, or

a specific State has been reached, or

a combination of the two (such as “12 hours after Release State has been reached”)

This field postpones usage of the content body by users outside a specified scope (e.g. outside This newsroom only or All our newsrooms)

Exception Rights

Even with this type of granularity, embargoes on some content objects simply require their use to be negotiated separately. In such cases, Exception rights can be flagged, completely prohibiting use of the content body by users outside a specified scope (e.g. outside This newsroom only or All our newsrooms), and a text message (“Call this number for details”) to be added for all prospective buyers to see.

Pre-Defined Access Rules

Needless to say, Access fields will not be set explicitly for each and every content object. It is possible for system administrators to set defaults for Access fields based on Type, Desk, State and other field values.

Tracking External use of Contents

The fact that some external user can access and use a content object doesn't mean that he should not pay for it! The content management system needs ways of tracking which users actually ordered individual content objects and the ability to collect and export that information for administrative and billing purposes.

Automating Actions

Smaller and larger adjustments in workflow as a result of changed or added products and reorganizing of newsroom staff, will all be much more common events in a content focused publishing environment compared to a “traditional” newspaper. The content management system needs to automate as many tasks as possible while still allowing for such changes. These requirements can be boiled down to the need for a general mechanism for automating various actions. Of course NewsDesk already allows actions to be triggered at certain events. What is needed in the content management system is to expand this model and add a user interface.

Defining Automation Rules and Actions

Whenever a content object is entered, modified or deleted, it is checked against a series of rules that may trigger actions on the content object. Needless to say these rules and actions should run on the database server.

Examples of such rules and actions are:

Send a notification message to a user or group of users whenever a content object with certain words in its abstract is entered.

Route all graphics objects to these baskets when they reach a certain State (or hit some other combination of field values).

Convert the content body of this particular photo request into GIF and export it to this file system directory as soon as it enters the database (i.e. content body is not empty)—regardless of its state (say, because it needs Web-specific editing and we don't want to wait for toning and stuff to be completed).

These are not the requirements themselves but merely examples of such rules and actions that might be used.

Each automation rule is much like a list window filter, allowing tests for any Boolean combination of metadata field values. Whenever a content object is entered, modified or deleted, its metadata fields are checked against the entire set of rules. If the conditions are met, each rule can trigger an action. It is absolutely possible for several rules to match, in which case they all should fire. Also, each rule can trigger an entire sequence of actions.

Supported Automation Actions

The content management system should include a number of standard actions. Examples of such standard actions might be Notify, Route, Convert and Export. Of course other actions can be written by CCI or by trained super users.

User Interface

The user interface is sufficiently simple and intuitive that any reasonably trained user—not just super users—can define rules and select actions to run (among the supplied standard actions or any actions written by super users). The user interface should allow for metadata field values to be passed to the actions as parameters.

Permissions and Timeouts

Because improperly defined automation rules or poorly written actions can potentially wreak havoc with contents or tie up large amounts of server resources, it is possible to restrict user permissions to this feature. That includes the ability to define who can use each individual actions as well as who can set up rules at all. Also, to prevent infinite recursion from draining database power we need some way of killing actions after they have run for a specified amount of time. We might also allow super users to limit the number of simultaneous rules each user can establish.

Expiration of Rules

Often, rules are defined ad hoc to address a specific need while covering a certain news event. We can count on users to forget to clear those rules by the end of the day, thus causing them to run forever. Hence all rules should have an expiration date & time. Default for this expiration can be set by super users but overridden by users—probably still limited to some maximum, so that only super users can set non-expiring rules.

1. A content management system for use in news media production, comprising:
data storing means, data retrieving means and data processing means,
a database system adapted to store publishing content objects (PCOs) and metadata, the metadata being associated with PCOs in the content management system,
a number of workstations,
characterised in that
the PCOs are arranged to be media neutral so as to enable re-use of the PCOs in publications of multiple media, and that
the content management system further facilitates planning and co-ordinating of usage of PCOs in one or more publications.

2. A content management system according to claim 1, wherein the PCOs are arranged to be media neutral by comprising content elements divided by their function.

3. A content management system according to claim 1, wherein the PCOs are arranged to be media neutral by storing or managing them using an XML based structure.

4. A content management system according to claim 1, wherein the planning and co-ordinating of usage of PCOs in one or more publications is achieved by maintaining relations between anticipated news stories and said publications.

5. A content management system according to claim 1, wherein the planning and co-ordinating of usage of PCOs comprises tentative or dynamic planning and co-ordinating of usage of the PCOs and/or fixed planning and co-ordinating of usage of the PCOs.

6. A content management system according to claim 1, wherein the planning and co-ordinating of usage of PCOs comprises approximate and/or specific placement of PCOs, said placement referring to physical or visual location of PCOs in one or more publications being planned.

7. A content management system according to claim 1, wherein the planning and co-ordinating of usage of PCOs comprises planning and co-ordinating of PCOs that are only planned for creation or still under creation or already existing PCOs.

8. A content management system according to claim 1, wherein the PCOs comprise content of types used in news media selected from the group consisting of: daily or weekly newspapers, magazines, TV and radio stations, Internet sites and other electronic news media.

9. A content management system according to claim 1, wherein the planning and co-ordinating of usage of PCOs is performed by associating PCOs and information relating to PCOs with one or more layout budgets or lists, each layout budget or list having at least one publication associated with it, and each layout budget or list representing the planned content of the associated publication(s) or a part or section thereof.

10. A content management system according to claim 1, wherein layout budgets or lists have at least one publication date and/or time associated with them, the publication date and/or time indicating the publication date and/or time of a publication associated with the layout budget or list.

11. A content management system according to claim 1, wherein PCOs are added to or removed from layout budgets or lists or wherein information relating to PCOs is changed on layout budgets or lists, thereby facilitating dynamic planning of content intended for use in publications.

12. A content management system according to claim 1, wherein metadata are used for approving or suspending PCOs associated with layout budgets or lists, thereby facilitating tentative or preliminary planning of individual PCOs intended for use in publications.

13. A content management system according to claim 1, further comprising means for filtering or sorting of PCOs based on their metadata, thereby facilitating presentation of an output according to said filtering or sorting.

14. A content management system according to claim 1, wherein metadata are used for ranking or prioritising PCOs by associating one rank or priority out of a plurality of ranks or priorities with the metadata for a given PCO.

15. A content management system according to claim 14, further comprising means for arranging the ranks or priorities of PCOs in a hierarchical structure.

16. A content management system according to claim 1, further comprising means for associating a size with each PCO, the size indicating physical or visual space or time duration of the PCO when appearing in a publication.

17. A content management system according to claim 1, further comprising means for associating a size with each PCO, the size indicating actual measured size or a planned size of the PCO when appearing in a publication.

18. A content management system according to claim 1, wherein a layout budget or list has a predefined maximum total size indicating the space or time available within a publication or a part or a section thereof being associated with the layout budget or list.

19. A content management system according to claim 1, wherein at least one workstation provides access to the database system and all PCOs managed in the database system, irrespective of the storage location of any particular PCO.

20. A content management system according to claim 1, wherein the database system comprises a plurality of databases.

21. A content management system according to claim 20, wherein the plurality of databases is physically or geographically disparate.

22. A content management system according to claim 20, wherein each database of the plurality of databases is adapted to store PCOs and associated metadata for a particular enterprise or a branch of an enterprise.

23. A content management system according to claim 20, wherein each database of the plurality of databases comprises a searchable index of the metadata and/or content associated with the PCOs stored in that database.

24. A content management system according to claim 23, wherein the searchable indices are synchronised into a consolidated index, thereby facilitating a consolidated access to or view of the PCOs stored in the plurality of databases.

25. A content management system according to claim 20, wherein a central searchable index of metadata and/or content associated with the PCOs stored in the plurality of databases is provided, thereby facilitating a consolidated access to or view of the PCOs stored in the plurality of databases.

26. A content management system according to claim 1, wherein a consolidated access to or view of PCOs is provided, irrespective of their storage location or database.

27. A content management system according to claim 1, further comprising means to support users from at least one workstation to perform the management task of tracking the status of one or more PCOs.

28. A content management system according to claim 1, further comprising means to support users to perform, from at least one workstation, the management task of associating metadata with one of a plurality of desk budgets, the desk budgets providing a list of PCOs that are planned or under creation within a given desk or department.

29. A content management system according to claim 1, further comprising means for supporting users from at least one workstation to perform the management task of organising PCOs into groupings.

30. A content management system according to claim 29, wherein the means for organising PCOs into groupings comprises
means for defining projects or projects and sub-projects in the content management system, and
means for including one or more PCOs in one or more projects or sub-projects, thereby facilitating an overview of PCOs involved in larger news events.

31. A content management system according to claim 30, further comprising means for arranging the projects and sub-projects in a hierarchical structure.

32. A content management system according to claim 30, further comprising means for filtering PCOs by project or sub-project, thereby facilitating a presentation of PCOs related to the project or sub-project.

33. A content management system according to claim 30, wherein metadata are associated with projects or sub-projects, thereby providing information relating to the project or sub-project.

34. A content management system according to claim 33, wherein at least part of the metadata associated with a given project or sub-project is applied to the PCOs included in that project or sub-project.

35. A content management system according to claim 29, wherein the means for organising PCOs into groupings comprises means for associating a selected plurality of PCOs, irrespective of other groupings in which they might be included, so as to form an association, thereby facilitating any subject, topical or other desired relationship between PCOs.

36. A content management system according to claim 35, further comprising means for filtering PCOs by association, thereby facilitating a presentation of associated PCOs.

37. A content management system according to claim 35, further comprising means for linking between a PCO and any of its associated PCOs, thereby facilitating automatic or simplified maintenance of link relationships between associated PCOs.

38. A content management system according claim 35, further comprising means for assembling associated PCOs into packages intended or suggested for collective publication.

39. A content management system according to claim 35, further comprising means for describing the category or nature of a given PCO's relationship with its associated PCOs.

40. A content management system according to claim 1, wherein the database system comprises means for creating one or more assignments, each assignment being an administrative entity for managing one or more PCOs, the PCO(s) being planned for creation or still under creation or already existing PCO(s).

41. A content management system according to claim 40, further comprising means for associating metadata with assignments.

42. A content management system according to claim 41, wherein at least part of the metadata associated with an assignment applies to one or more PCOs being managed through that assignment as well as to the assignment itself.

43. A content management system according to claim 41, wherein the metadata comprises at least one of the following types of information relating to assignment management:
an address and/or name of a geographical location of a news event
one or more people expected to attend a news event
a start time and/or end time and/or duration of a news event
one or more contacts at a news event
one or more appointments at a news event
one or more items of research information or interviews or links to such items
a deadline

44. A content management system according to claim 1, wherein the metadata comprises at least one of the following types of information:
a slug or name
a description
an origination
a type
a status
a reference to at least one publication
keywords
an abstract or summary
notes
a modification log
access control information
an originating newsroom
an originating desk
an assignment editor
an author
a deadline
intellectual property rights

45. A content management system according to claim 1, wherein the metadata comprises at least one of the following types of information referring to a publication:
a name
a publication date and/or time
a revision specific edition
a geographical or topical edition
a logical or physical storage address in a computer system
a specific physical or visual placement or location within the publication
a deadline
a layout budget or list associated with the publication
a size of the publication or within in the publication
a ranking or priority within the publication

46. A content management system according to claim 1, further comprising means for ensuring that metadata contain only valid combinations of information.

47. A content management system according to claim 1, wherein the metadata comprises at least one of the following types of information relating to access control:
permissions to view the existence of an item in the database system
permission types and/or levels of access to an item in the database system
rules specifying conditions for specific permissions to take effect on an item in the database system

48. A content management system according to claim 1, wherein at least part of the metadata are stored as database fields in the database system.

49. A content management system according to claim 1, wherein at least part of the metadata are stored as tags and/or attributes within the content associated with PCOs.

50. A content management system according to claim 1, wherein the database system comprises means for enabling a system administrator or workstation user to define one or more additional metadata fields, thereby facilitating customised information to be stored in the database system.

51. A content management system according to claim 1, wherein a set of metadata fields is definable by a system administrator or workstation user.

52. A content management system according to claim 50 , wherein substantially all metadata fields are definable by a system administrator or workstation user.

53. A content management system according to claim 1, wherein a set of metadata fields is definable by the content type of a given PCO.

54. A content management system according to claim 1, wherein at least some PCOs or other database items stored in the database system are associated with specific icons, thereby allowing a workstation user to identify the type of item by a visual appearance of its icon.

55. A content management system according to claim 1, wherein changes to metadata or changes to content associated with PCOs are logged during a news media production workflow.

56. A content management system according to claim 1, wherein automation rules defined by system administrators or by workstation users enable triggering of automatic actions based on changes to metadata values or changes to content associated with PCOs.

57. A content management system according to claim 56, wherein at least one of the following tasks are triggered when the condition of an automation rule is met:
notifying or alerting users
triggering workflow events
triggering user specified actions
triggering automatic archival or purging
triggering a routing of PCOs or other database items

58. A content management system according to claim 1, wherein production and/or publication of media output using the PCOs stored in the database system is facilitated by one or more production systems integrated with the database system.

59. A content management system according to claim 58, wherein PCOs or at least some metadata associated with PCOs stored in the database system are accessible from a production system.

60. A content management system according to claim 58, wherein PCOs or at least some status or production data or other metadata from a production system are accessible from the content management system.
